(19) United States
(12) Patent Application Publication
(10) Pub. No.: US 2010/0061318 A1
(43) Pub. Date: Mar. 11, 2010

(54) CHANNEL SCAN METHOD AND ARCHITECTURE FOR WIRELESS COMMUNICATION SYSTEMS

(75) Inventors: Kuo-Tai Chiu, Taoyuan County (TW); Yun-Yi Shih, Tainan County (TW); Yao-Yi Huang, Taipei City (TW); Pang-An Ting, Taichung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/420,956

(22) Filed: Apr. 9, 2009

(30) Foreign Application Priority Data
Sep. 5, 2008 (TW) 97134256

(51) Int. Cl. H04W 4/00; H04B 17/00

(52) U.S. Cl. 370/329; 455/67.11

(57) ABSTRACT

In wireless communication system and method, a guard band detection (GBD) is performed in a channel to detect the existence of guard bands of a correct channel, so to predetermine that whether the current channel is correct or not. If GBD and a subsequent authorization are both passed in the channel, then the channel is determined as the correct channel. Besides, multiple point estimation (MPE) can be used to analyze the signal strengths in different frequencies to predict the location of the correct channel.

This application claims the benefit of Taiwan application Serial No. 97134256, filed Sep. 5, 2008, the subject matter of which is incorporated herein by reference.

### BACKGROUND OF THE INVENTION

1. Field of the Invention

The invention relates in general to a wireless communication system and method, and more particularly to a channel scan method and architecture for wireless communication system.

2. Description of the Related Art

Worldwide interoperability for microwave access (WiMAX), having larger bandwidth, farther transmission distance, larger on-line coverage, has become a focus in wireless Network or mobile communication.

Currently, WiMAX products comprises WIMAX wireless Network card for notebook computer, USB interface WiMAX wireless Network card, WiMAX modem, WiMAX wireless broad band router, and mobile phone adopting WiMAX specification.

In WiMax application, how to quickly scan correct channel and center frequency is an important issue to be resolved.

In generally known techniques, a channel is randomly or sequentially selected from many candidate channels (from high frequency to low frequency, or from low frequency to high frequency). Next, timing synchronization, estimation, decoding, authorization and so on are performed in the selected channel. If authorization is passed in the selected channel, this implies that the selected channel is a correct channel. If authorization is not passed in the selected channel, then a next channel is randomly or sequentially selected from many candidate channels (from high frequency to low frequency, or from low frequency to high frequency) until a correct channel is scanned.

United States Patent Application Publication No. US200310027577 discloses a control apparatus and method of wireless communication system for scanning which frequency bands are available. FIG. 7 of United States Patent Application Publication No. US2003/0027577 shows a method for determining frequency spectrum. Firstly, frequency spectrum is analyzed. Next, average operation and smooth operation are performed in the analyzed frequency spectrum. Then, a threshold is set. If the signal strength in one or some channels is higher than the threshold, then the channel(s) is regarded as occupied. After that, a guard band (GB) is disposed at two sides of the occupied channel. Afterwards, the frequency bands other than the occupied channel and the guard band are defined as available. That is, United States Patent Application Publication No. US2003/0027577 determines the location of the guard band according to the frequency spectrum density, to determine which frequency bands are available.

### SUMMARY OF THE INVENTION

According to a first aspect of the present invention, a wireless communication method is provided. The method comprises the following steps. A channel is selected from a plurality of channels. A guard band detection (GBD) is performed in the selected channel to detect existence of a guard band of a correct channel. If the GBD is passed in the selected channel, then a subsequent process is performed in the selected channel. If the subsequent process is passed in the selected channel, then the selected channel is determined as the correct channel.

According to a second aspect of the present invention, a wireless communication method is provided. The method comprises the following steps. Signal strengths in different frequencies are measured respectively. It is checked that whether these signal strengths are conformed to the conditions. If so, then a frequency is predicted according to these signal strengths and a channel is selected according to the predicted frequency. If a subsequent process is passed in the selected channel, then the selected channel is determined as the correct channel.

According to a third aspect of the present invention, a wireless communication method is provided. The method comprises the following steps. Signal strengths in different frequencies are measured respectively. It is checked that whether the characteristics of these signal strengths are conformed to a condition. If so, then a frequency is predicted according to the characteristics of these signal strengths and a channel is selected according to the predicted frequency. A GBD is performed in the selected channel to detect the existence of guard bands of a correct channel. In order to determine whether the selected channel is the correct channel, it is checked that whether the GBD and a subsequent process are both passed in the selected channel.

According to a fourth aspect of the present invention, a wireless communication system is provided. The wireless communication system comprises a channel selection module, a GBD module, and a subsequent processing module. The channel selection module is used for selecting one channel from a plurality of channels. The GBD module is coupled to the channel selection module, for performing a GBD in the selected channel to detect the existence of guard bands of a correct channel. The subsequent processing module is coupled to the GBD module, for performing a subsequent process in the channel where has been passed the GBD, wherein if the subsequent process is passed in the channel, then the selected channel is determined as the correct channel.

The invention will become apparent from the following detailed description of the preferred but non-limiting embodiments. The following description is made with reference to the accompanying drawings.

### BRIEF DESCRIPTION OF THE DRAWINGS

FIG. 1 shows one of the spectrum mask;

FIG. 2 shows a known flowchart for scanning a correct channel;

FIG. 3 shows a flowchart of a GBD method for scanning correct channel according to a first embodiment of the invention;

FIG. 4 shows the grouping of bandwidths;

FIG. 5 shows a flowchart of a GBD method for scanning correct channel according to a second embodiment of the invention;

FIG. 6 and FIG. 7 show simulation models.

FIG. 8 shows a flowchart of a GBD method for scanning correct channel according to a third embodiment of the invention;

FIG. 9 shows a flowchart of a GBD method for scanning correct channel according to a fourth embodiment of the invention;

FIG. 10 shows a flowchart of a GBD method for scanning correct channel according to a fifth embodiment of the invention;

FIG. 11A and FIG. 11B show signal strengths measured in three different frequency locations in a sixth embodiment of the invention;

FIG. 12 shows a flowchart of a GBD method for scanning correct channel according to a sixth embodiment of the invention;

FIG. 13 shows a flowchart of a GBD method for scanning correct channel according to a seventh embodiment of the invention;

FIG. 14A˜FIG. 14D show simulation curves obtained according the seventh embodiment (solid line) and the second embodiment (dotted line) of the invention;

FIG. 15 shows a function block diagram of wireless communication system according to an eighth embodiment of the invention;

FIG. 16 shows a function block diagram of wireless communication system according to a ninth embodiment of the invention; and

FIG. 17 shows a function block diagram of wireless communication system according to a tenth embodiment of the invention.

### DETAILED DESCRIPTION OF THE INVENTION

Embodiments of the invention provide wireless communication systems and methods using guard band detection (GBD), which are capable of predetermining whether the current channel is correct. Only if the channel is correct will subsequent operations such as timing synchronization, decoding, authorization and so on be performed. Other embodiments of the invention provides wireless communication systems and methods using multiple point estimation (MPE), which are capable of predicting approximate location of the correct channel, and then performing subsequent operations in the predicted channel. Yet other embodiments of the invention provide a wireless communication system and method using GBD and MPE, which are capable of predicting the location of correct channel and predetermining whether the current channel is correct.

### First Embodiment

In wireless communication system, radio frequency channels are normally disposed in a particular frequency band. Generally speaking, there are many candidate channels. For example, under IEEE 802.16e specification, radio frequency profile (RF profile) is expressed as follows:

Fₛₜₐᵣₜ+k·ΔF_{c}, ∀k ∈ K_{range}, wherein
Fₛₜₐᵣₜ is the start frequency of particular frequency band;
ΔF_{c} is the step size of center frequency;
k is a parameter;
K_{range} is the range of parameter k.

Let the channel bandwidth be 10 MHz, K_{range} range from 0 to 736, and ΔF_{c} be 250 KHz.

For example, when the wireless device is re-started but the wireless device does not store any useful data or the stored data is already outdated, all channels must be scanned in order to scan the correct channel. Besides, when the wireless device roams between two wireless Network areas, all the channels must be scanned.

In the first embodiment of the invention, in detecting the guard band, approximate location of the correct channel is scanned first, so that authorization times and the time spent are decreased, and the scanning of channel and frequency is speeded up.

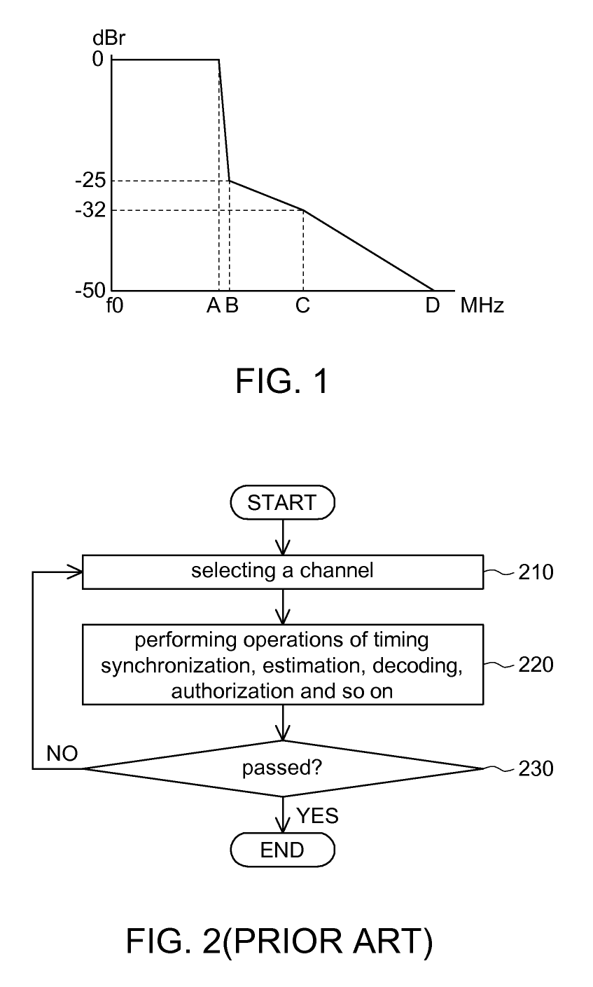

In wireless communication, one specification of the spectrum mask is illustrated in FIG. 1. In FIG. 1, the horizontal axis denotes frequency, the vertical axis denotes signal strength, f₀ denotes center frequency, and A˜D denote different frequencies respectively. The frequencies A˜D may be varied with the specifications of the systems.

As indicated in the spectrum mask of FIG. 1, signal strengths are lower in some frequency bands called “guard bands”. In the guard bands, the licensed band in particular, signal strengths are lower and there is no jamming signal. Besides, in the frequency spectrum, the guard bands are normally disposed at two sides of the signal symmetrically. Thus, when signal strength at two sides of a particular channel is lower, the channel could be likely the correct channel.

In the first embodiment of the invention, before performing subsequent operations such as timing synchronization, authorization and so on, it is checked that whether the channel is close to the correct channel or is exactly the correct channel. Normally, there are still many operations needs to be done before the operation of authorization is completed. By predetermining whether the channel is close to the correct channel or is exactly the correct channel, a lot of time and power are saved because the times and time of subsequent operations performed in incorrect channel are reduced.

FIG. 2 shows a known flowchart for scanning a correct channel. As indicated in FIG. 2, the method begins at step 210, a channel is selected. Next, operations of timing synchronization, estimation, decoding, authorization and so on are performed in the selected channel as indicated in step 220. Then, it is checked that whether authorization is passed as indicated in step 230. If authorization is passed, this implies that the channel should be a correct channel. If authorization is not passed, then the method returns to step 210 to scan the next channel.

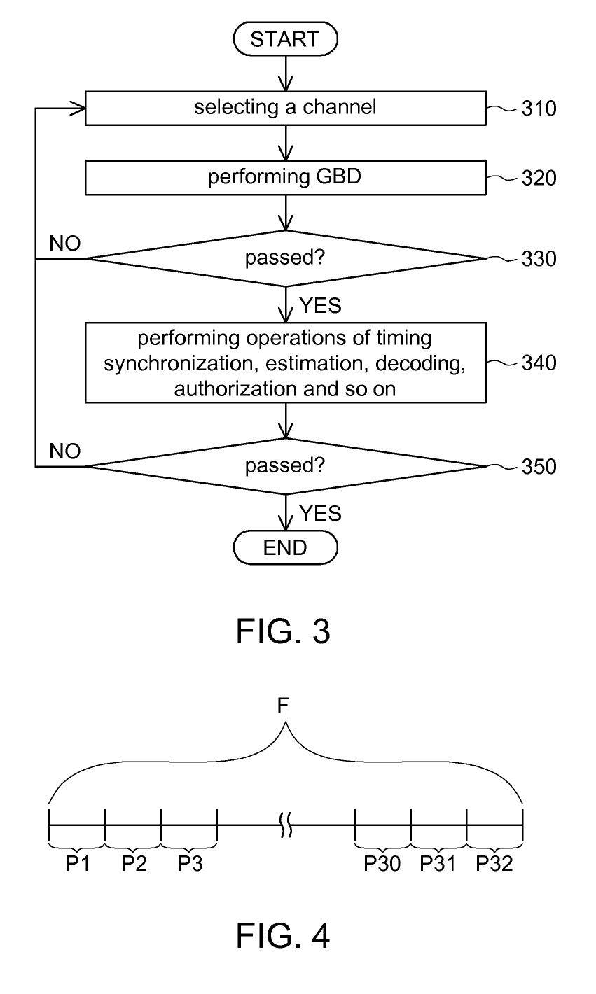

The first embodiment of the invention provides a guard band detection (GBD) method. FIG. 3 shows a flowchart of a GBD method for scanning correct channel according to the first embodiment of the invention.

As indicated in FIG. 3, the method begins at step 310, a channel is randomly or sequentially selected from many candidate channels (from high frequency to low frequency, or from low frequency to high frequency). Next, GBD is performed in the selected channel as indicated in step 320. The operation of GBD is disclosed below. Then, the method proceeds to step 330, it is checked that whether GBD is passed in the channel (that is, whether the guard band is located). In the present embodiment of the invention, the channel having been passed GBD is regarded as close to the correct channel.

If the GBD is not passed in the channel, then the next channel is selected, and the method returns to step 310. If the GBD is passed in the channel, then operations of timing synchronization, estimation, decoding, authorization and so on are performed in the selected channel as indicated in step 340.

Afterwards, it is checked that whether authorization is passed as indicated in step 350. If authorization is passed in the channel, this implies that the channel is exactly a correct channel. If authorization is not passed in the channel, then the method returns to step 310.

As indicated in FIG. 3, in the first embodiment of the invention, subsequent operations such as timing synchronization, estimation, decoding, authorization and so on are firstly performed in the channel having been passed the GBD).

The operation of the GBD is disclosed below. Suppose the channel bandwidth is 10 MHz, sampling frequency is 11.2 MHz, the size of fast Fourier transformation (FFT size) is 1024. Also, suppose the time length of a frame is 5 ms.

FIG. 4 shows the grouping of bandwidths. As indicated in FIG. 4, many continual sub-carriers in a bandwidth F of the selected channel are divided into many sub-groups. For example, 1024 continual sub-carriers in a bandwidth are equally divided into 32 sub-groups each having 32 continual sub-carriers.

Next, an average power value is obtained from 32 continual sub-carriers in the same sub-group. By the same token, 32 average power values are obtained which are P1˜P32 corresponding to 32 sub-groups respectively.

Next, 8 smallest values of the 32 average power values P1˜P32 are located and stored.

After that, it is checked that whether the average power values P2, P3, P30 and P31 are among the 8 smallest values. If there are two or more of the average power values P2, P3, P30 and P31 among the 8 smallest values, this implies that GBD is passed in the channel. As disclosed above, there are guard bands at two sides of the correct channel, and the signal strength is very strong in the correct channel but very weak in the guard band. If in the bandwidth, sub-carrier sub-groups at two sides have lower average power (lower signal strength) but sub-carrier sub-groups at middle have higher average power (higher signal strength), this implies that the center frequency of the bandwidth falls within the correct channel or is close to the correct channel.

If GBD is not passed on 4 continual frames in the channel, this implies that the channel is farther away from the correct channel. Under such circumstances, a next channel is selected (that is, a next center frequency is selected). On the other hand, if the GBD is passed on one of the 4 continual frames in the channel, this implies that the channel is likely being a correct channel, or, the channel is close to the correct channel.

In short, according to the first embodiment of the invention, GBD is performed in the selected channel so as to predetermine whether the channel is a correct channel or the channel is close to the correct channel.

### Second Embodiment

The second embodiment of the invention still uses GBD and avoids performing authorization in these channels farther away from the correct channel. The second embodiment of the invention further discloses how to appropriately select channel before GBD is performed.

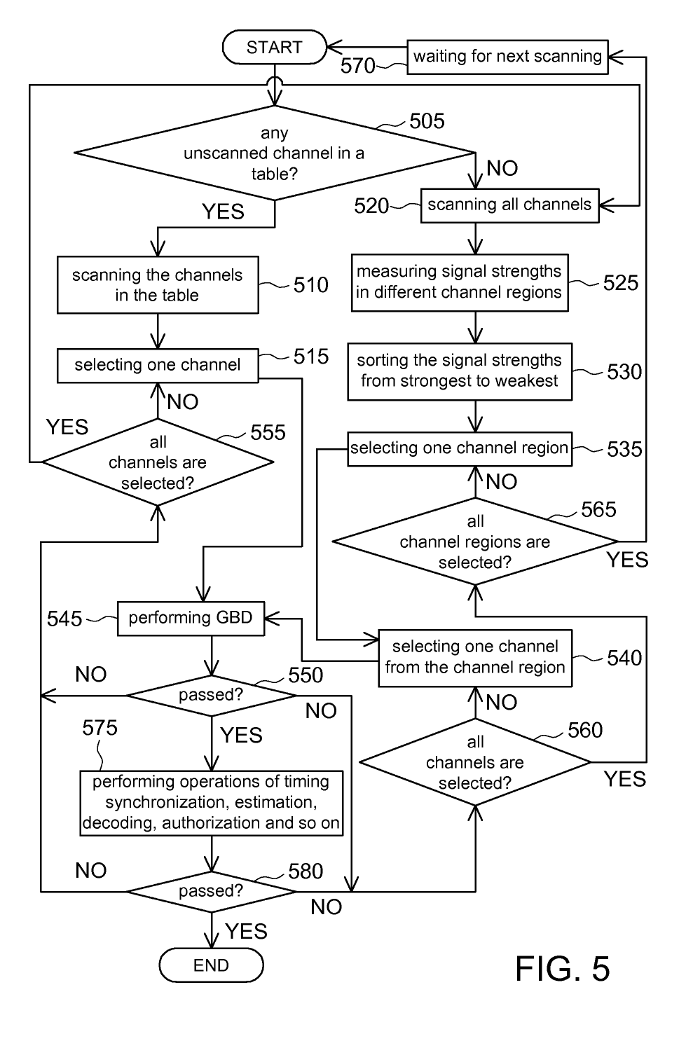

FIG. 5 shows a flowchart of a GBD method for scanning correct channel according to the second embodiment of the invention. As indicated in FIG. 5, in step 505, it is checked that whether there are unscanned channels in the table (list) of the wireless device. If there are unscanned channels, the method proceeds to step 510, otherwise, the method proceeds to step 520.

Next, in step 510, the channels in the table are scanned. The channels listed in the table could be the correct channel previously used by the wireless device, or, the channels listed in the table are more likely a correct channel. In step 515, a channel is selected.

If the check result in step 505 is no (that is, there are unscanned candidate channels in the table), then the method proceeds to step 520 to scan all the channels.

In step 520, the overall frequency band range is divided into several channel regions and the signal strengths in these channel regions are measured. For example, each channel region covers 10 MHz.

Afterwards, in step 530, the signal strengths measured in each channel region are sorted from the strongest to the weakest. Then, in step 535, one of the channel regions is selected according to the result of sorting. For example, the channel region with strongest signal strength is selected because such channel region is most likely covering the correct channel.

After that, in step 540, a channel is selected from the channel region.

After a channel is selected in step 515 or step 540, GBD is performed in the channel, as indicated in step 545. The details of performing the GBD are disclosed in the first embodiment, and are not repeated here.

Then, in step 550, it is checked that whether GBD is passed in the channel, so as to determine whether the channel is a correct channel or is close to correct channel. If the check result in step 550 is yes, then the method jumps to step 575. If the checking result in step 550 is no and the channel is selected in steps 510˜515, then the method jumps to step 555. On the other hand, if the check result in step 550 is no and the channel is selected according to steps 520˜540, then the method jumps to step 560.

In step 555, it is checked that whether all the channels in the table are selected. If not all candidate channels are selected yet, then the method returns to step 515, to select a next candidate channel. If all candidate channels are already selected, this implies that all the channels are not correct channel, and the method jumps to step 570.

In step 560, it is judged that whether all the candidate channels in the selected channel region are selected. If no, then the method returns to step 540 to select a next candidate channel. If all the candidate channels in the channel region are selected already, then the method jumps to step 565.

In step 565, it is checked that whether all channel regions are selected. If no, then the method jumps to step 535 to select a next channel region. If all channel regions are selected, this implies that all the candidate channels in the channel region are not correct channel, and the method jumps to step 570.

In step 570, correct channel cannot be scanned from existing candidate channels, so the method waits for the next scanning.

In step 575, timing synchronization, estimation, decoding, authorization and so on are performed in the channel having been passed GBD. In step 580, it is checked that whether authorization is passed. If authorization is passed, then this implies that correct channel is scanned. If authorization is not passed, then the method jumps to step 555 (if the channel is selected according to steps 510˜515) or to step 560 (if the channel is selected according to steps 550˜540).

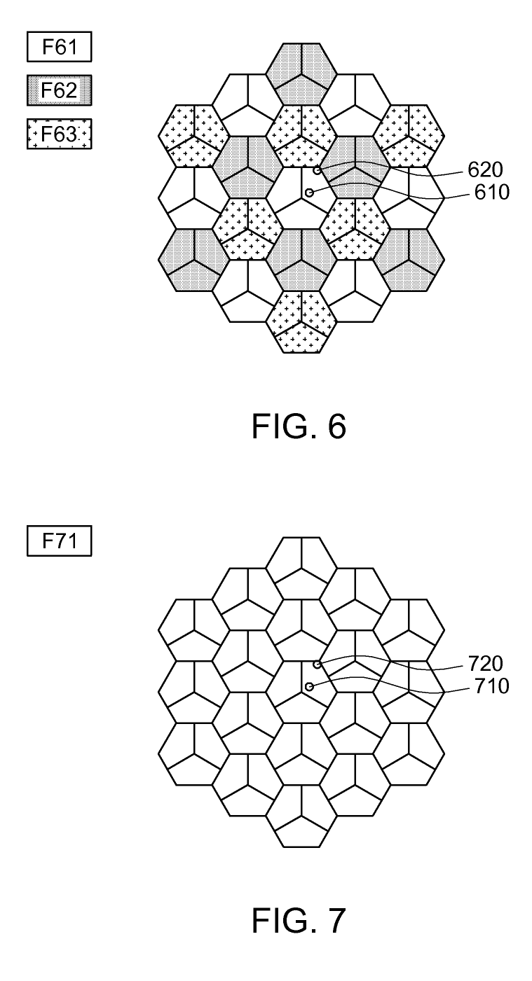

FIG. 6 and FIG. 7 show simulation models. In simulation, sampling frequency is 44.8 MHz, so the range of the simulated frequency is restricted within the range of −22.4 MHz˜+22.4 MHz. In simulation, K_{range} ranges (−80)˜(+80), and the center frequency F_{c} falls within (2.5 GHz−20 MHz)˜(2.5 GHz+20 MHz). Besides, in simulation, the path loss model is Hata urban model, the cell radius is 1 km, and the cell plan is 3×3×3 (FIG. 6) or 1×3×3 (FIG. 7). In FIG. 6 and FIG. 7, the quantity of cells is 19. However, simulation can be done by other quantities of cells.

In the case of cell plan 1×3×3, there is only one particular unknown center frequency (F71), the bandwidth is 10 MHz, and each cell has three sectors and three segments. In the case of cell plan 3×3×3, there are three different unknown center frequencies (F61˜F63), each center frequency has a bandwidth of 10 MHz, and each cell has three sectors and three segments. Besides, suppose the user (that is, the wireless device) is located at two possible locations, one is the middle location 610 and 710 close to the base station; and the other is the cell edge location 620 and 720 close to the cell boundary.

Besides, in simulation, there are two types of channel model, namely, additive white Gaussian noise (AWGN) and VA 60 Km/Hr. Under these conditions, the simulation results of the second embodiment of the invention are disclosed in Table 1, 2, 3. In Table 1˜Table 3, “x” denotes irrelevant data.

Table 1 lists how many channels are scanned (that is, the times of scanning channels).

Suppose it takes 15 frames to complete subsequent operations (such as timing synchronization, decoding, authorization and so on), then the required time for overall scanning is listed in Table 2.

As indicated in Table 3, the scanning process of the second embodiment of the invention is faster than the known scanning process by about 30% of time.

TABLE 1

| | | User | Channel | Best | Mediocre | Worst |
|---|---|---|---|---|---|---|
| Cell Plan | Cell Quantity | Location | Type | Scenario | Scenario | Scenario |
| 3 × 3 × 3 | 1 | Middle | AWGN | 1 | 20 | 80 |
| | | Location | VA | 1 | 20 | 80 |
| | | | 60 Km/hr | | | |
| | | Cell Edge | AWGN | 1 | 20 | 80 |
| | | | VA | 1 | 20 | 80 |
| | | | 60 Km/hr | | | |
| | 7 | Middle | AWGN | 1 | 19 | 40 |
| | | Location | VA | 1 | 19 | 40 |
| | | | 60 Km/hr | | | |
| | | Cell Edge | AWGN | 1 | 19 | 40 |
| | | | VA | 1 | 19 | 40 |
| | | | 60 Km/hr | | | |
| | 19 | Middle | AWGN | 1 | 19 | 40 |
| | | Location | VA | 1 | 20 | 77 |
| | | | 60 Km/hr | | | |
| | | Cell Edge | AWGN | 1 | 19 | 40 |
| | | | VA | 1 | 19 | 40 |
| | | | 60 Km/hr | | | |
| 1 × 3 × 3 | 7 | Middle | AWGN | 1 | 20 | 80 |
| | | Location | VA | 1 | 21 | 77 |
| | | | 60 Km/hr | | | |
| | | Cell Edge | AWGN | x | x | x |
| | | | VA | 1 | 82 | 161 |
| | | | 60 Km/hr | | | |

TABLE 2

| | | User | Channel | Best | Mediocre | Worst |
|---|---|---|---|---|---|---|
| Cell Plan | Cell Quantity | Location | Type | Scenario | Scenario | Scenario |
| 3 × 3 × 3 | 1 | Middle | AWGN | 33 | 225 | 647 |
| | | Location | VA | 33 | 237 | 673 |
| | | | 60 Km/hr | | | |
| | | Cell Edge | AWGN | 33 | 224 | 764 |
| | | | VA | 33 | 244 | 825 |
| | | | 60 Km/hr | | | |
| | 7 | Middle | AWGN | 33 | 217 | 339 |
| | | Location | VA | 33 | 222 | 346 |
| | | | 60 Km/hr | | | |
| | | Cell Edge | AWGN | 33 | 216 | 443 |
| | | | VA | 33 | 236 | 477 |
| | | | 60 Km/hr | | | |
| | 19 | Middle | AWGN | 33 | 217 | 339 |
| | | Location | VA | 33 | 227 | 715 |
| | | | 60 Km/hr | | | |
| | | Cell Edge | AWGN | 33 | 232 | 439 |
| | | | VA | 33 | 236 | 547 |
| | | | 60 Km/hr | | | |
| 1 × 3 × 3 | 7 | Middle | AWGN | 33 | 225 | 662 |
| | | Location | VA | 33 | 242 | 663 |
| | | | 60 Km/hr | | | |
| | | Cell Edge | AWGN | x | x | x |
| | | | VA | 61 | 1956 | 3948 |
| | | | 60 Km/hr | | | |

TABLE 3

| | | User | Channel | |
|---|---|---|---|---|
| Cell Plan | Cell Quantity | Location | Type | Improvement Factor |
| 3 × 3 × 3 | 1 | Middle | AWGN | 37.45% |
| | | Location | VA | 34.05% |
| | | | 60 Km/hr | |
| | | Cell Edge | AWGN | 36.68% |
| | | | VA | 32.45% |
| | | | 60 Km/hr | |
| | 7 | Middle | AWGN | 35.92% |
| | | Location | VA | 33.76% |
| | | | 60 Km/hr | |
| | | Cell Edge | AWGN | 36.28% |
| | | | VA | 29.79% |
| | | | 60 Km/hr | |
| | 19 | Middle | AWGN | 35.92% |
| | | Location | VA | 35.04% |
| | | | 60 Km/hr | |
| | | Cell Edge | AWGN | 31.14% |
| | | | VA | 30.33% |
| | | | 60 Km/hr | |
| 1 × 3 × 3 | 7 | Middle | AWGN | 37.00% |
| | | Location | VA | 34.34% |
| | | | 60 Km/hr | |
| | | Cell Edge | AWGN | x |
| | | | VA | 40.38% |
| | | | 60 Km/hr | |

### Third Embodiment

The third embodiment of the invention still uses GBD and avoids performing authorization in these channels farther away from the correct channel. The third embodiment of the invention further discloses how to appropriately select channel before GBD is performed.

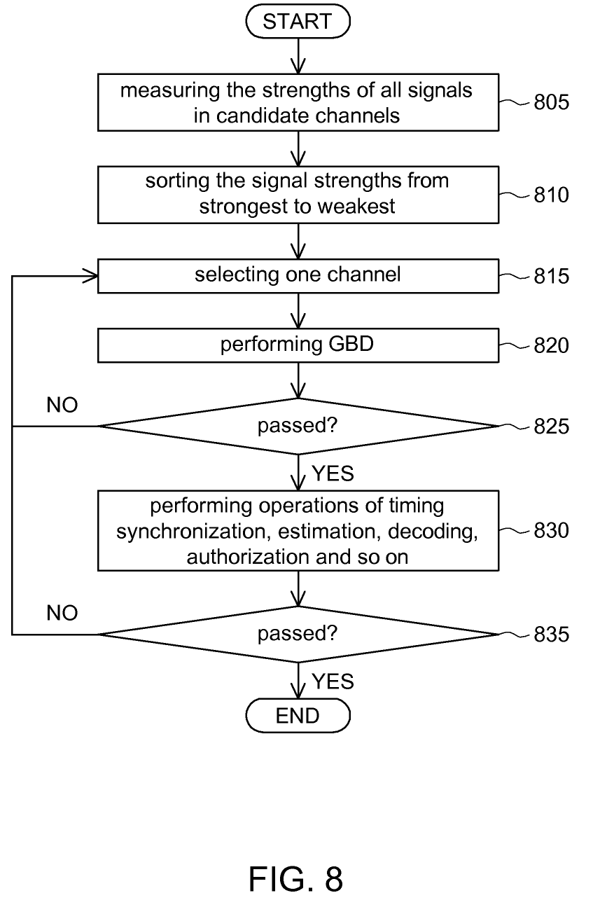

FIG. 8 shows a flowchart of a GBD method for scanning correct channel according to the third embodiment of the invention. As indicated in FIG. 8, in step 805, the strengths of all signals in candidate channels are measured. Next, in step 810, the signal strengths measured in each channel are sorted from the strongest to the weakest. Then, in step 815, one of the channels is selected according to the sort result. For example, the channel region with strongest signal strength is selected because such channel region is most likely the correct channel. After a channel is selected, GBD can be performed in the channel as indicated in step 820. The details of performing GBD are disclosed in the first embodiment, and are not repeated here.

After that, in step 825, it is checked that whether GBD is passed in the channel, so as to determine whether the channel is a correct channel or close to the correct channel. If the check result in step 825 is yes, then the method jumps to step 830. If the checking result in step 825 is no, then the method returns to step 815 to select the next channel.

In step 830, the operations of timing synchronization, estimation, decoding, authorization and so on are performed in the channel having been passed GBD. In step 835, it is checked that whether authorization is passed. If authorization is passed, this implies that a correct channel is scanned. If authorization is not passed, then the method jumps to step 815 to select the next channel.

### Fourth Embodiment

The fourth embodiment of the invention still uses GBD and avoids performing authorization in these channels farther away from the correct channel. The fourth embodiment of the invention further discloses how to appropriately select channel before GBD is performed.

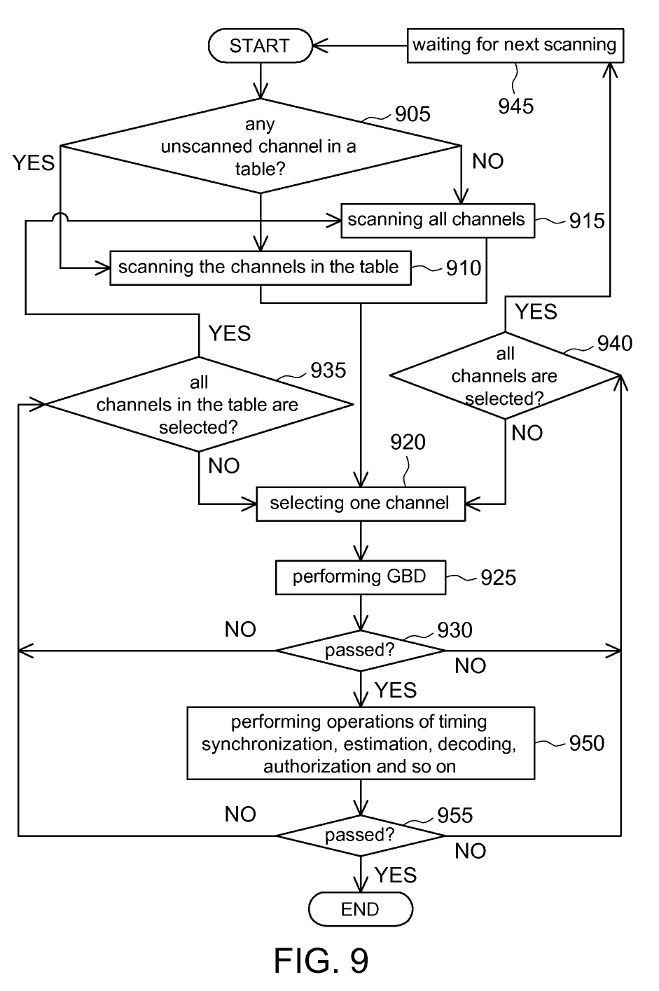

FIG. 9 shows a flowchart of a GBD method for scanning correct channel according to the fourth embodiment of the invention. As indicated in FIG. 9, it is check that whether there are unscanned channels in the table of the wireless devices in step 905 which is the beginning of the method. If yes, then the method jumps to step 910, otherwise, the method jumps to step 915.

In step 910, only the channels in the table are scanned. In step 915, all channels are scanned.

Next, in step 920, a channel is selected. Then, in step 925, GBD is performed in the selected channel. The details of performing GBD are disclosed in the above embodiments and are not repeated here. Then, it is checked that whether GBD is passed in the channel as indicated in step 930. If GBD is not passed and the channel is checked according to step 910, then the method jumps to step 935. On the other hand, if GBD is not passed and channel is selected according to step 915, then the method jumps to step 940. If the GBD is passed, then the method jumps to step 950.

In step 935, it is checked that whether all the channels in the table are selected. If no, then an unscanned channel is selected as indicated in step 920. If yes, then the method jumps to step 915 to scan all channels.

In step 940, it is checked that whether all the channels are selected. If no, then a next channel is selected as indicated in step 920. If yes, then the method jumps to step 945 to wait for the next scanning.

In step 950, the operations of timing synchronization, estimation, decoding, authorization and so on are performed in the channel having been passed the GBD. After that, in step 955, it is checked that whether authorization is passed. If authorization is passed, this implies that a correct channel is scanned. If authorization is not passed, then the method returns to step 935 (if channels are selected according to step 910) or step 940 (if channels are selected according to step 915).

### Fifth Embodiment

the fifth embodiment of the invention still uses GBD and avoids performing authorization in these channels farther away from the correct channel. The fifth embodiment of the invention further discloses how to appropriately select channel before GBD is performed.

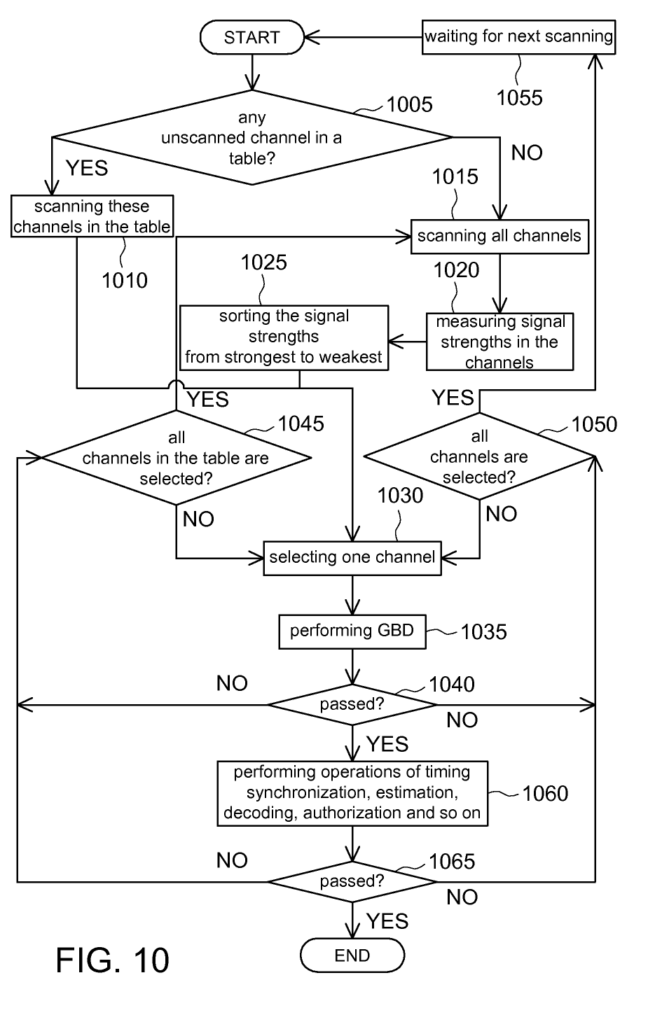

FIG. 10 shows a flowchart of a GBD method for scanning correct channel according to the fifth embodiment of the invention. As indicated in FIG. 10, in step 1005, it is checked that whether all the channels in the table of the wireless device are scanned. If yes, then the method jumps to step 1010, otherwise the method jumps to step 1015.

In step 1010, all the unscanned channels in the table are scanned.

In step 1015, all channels are scanned. In step 1020, the strengths of the signals in all channels are measured. Then, the method proceeds to step 1025 and the signal strengths are sorted from the strongest to the weakest.

After that, the method proceeds to step 1020 and a channel is selected. The channel which is selected could be the unscanned channels in the table (step 1010) or the channel with the strongest signal strength (steps 1010˜1025).

After that, the method proceeds to step 1035 and a GBD is performed in the selected channel. The details of performing GBD are disclosed in above embodiments and are not repeated here. Then, it is checked that whether GBD is passed in the channel as indicated in step 1040. If GBD is not passed and the channel is selected according to step 1010, then the method jumps to 1045. On the other hand, if GBD is not passed and the channel is selected according to steps 1015˜1025, then the method jumps to step 1050. If GBD is passed, then the method jumps to 1060.

In step 1045, it is checked that whether all channels in the table are selected. If no, then the next channel is selected as indicated in step 1020. If yes, then the method jumps to step 1015 and all channels are scanned.

Then, the method proceeds to step 1050 and it is checked that whether all channels are selected. If no, then the next channel is selected according to the result of sorting signal strengths as indicated in step 1030. If yes, then the method jumps to step 1055, and the method waits for the next scanning.

In step 1060, operations of timing synchronization, estimation, decoding, authorization and so on are performed in the channel having been passed GBD. Then, the method proceeds to step 1065 and it is checked that whether authorization is passed. If authorization is passed, this implies that correct channel is scanned. If authorization is not passed, then the method returns to step 1045 (if channel is selected according to step 1010) or step 1050 (if channel is selected according to steps 1015˜1025).

### Sixth Embodiment

The sixth embodiment of the invention uses a multiple-point estimation (MPE) method, wherein the location of correct channel is estimated and predicted according to the signal strengths in different frequencies.

The meaning of multiple points is disclosed below. Suppose that when the channel is getting closer to the correct channel, the signal strengths in the channel will become stronger and stronger. Thus, there are different signal strengths in different frequencies (channels). The meaning of multiple points is exemplified by three different frequencies (channels), also called points, below.

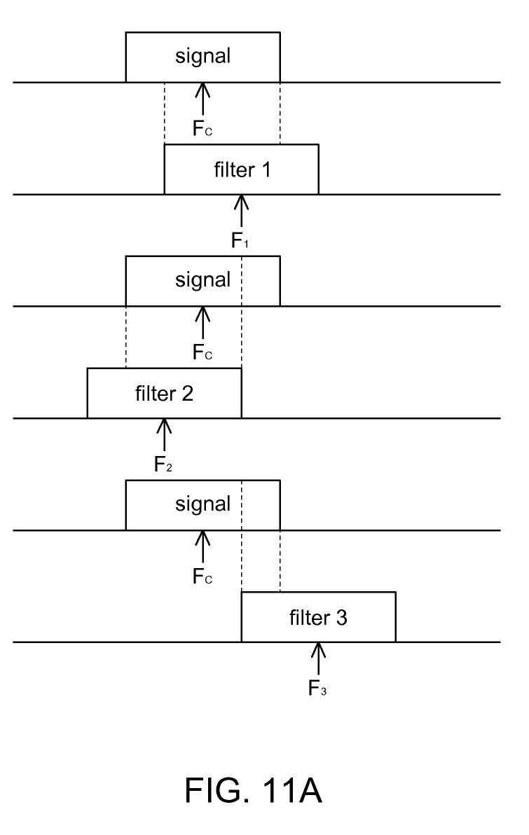

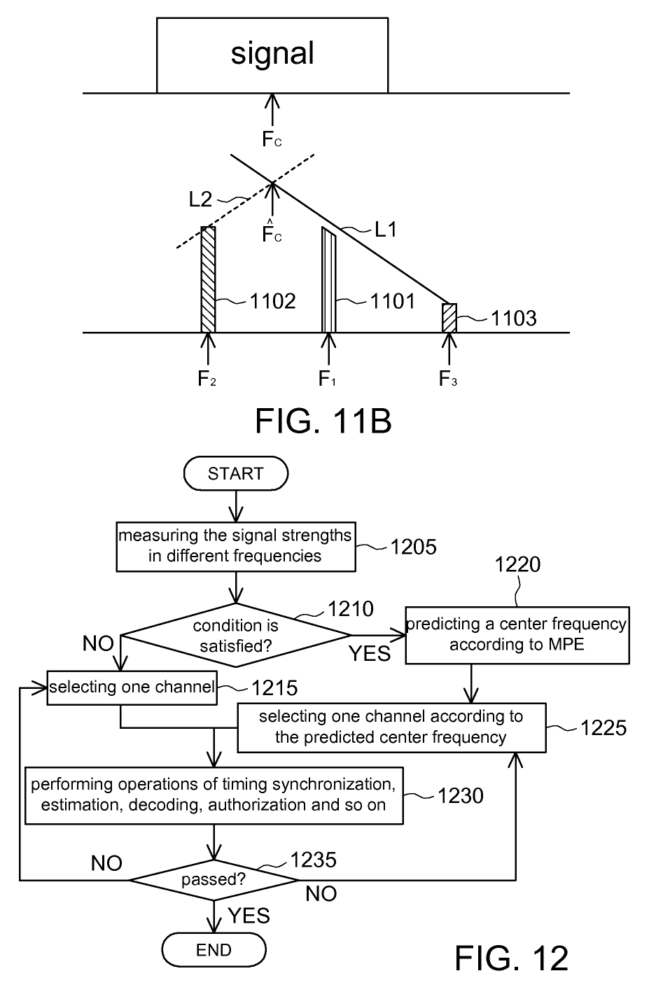

Referring to FIG. 11A, signal strengths measured in three different frequency locations in the sixth embodiment of the invention are shown. In FIG. 11A, symbol Fc denotes the (fixed) center frequency of the received signal, but the user (the wireless device) does not know where the center frequency is.

In the sixth embodiment, filters 1˜3 are used for measuring the signal strengths of the received signal. The center frequencies of filters 1˜3 are respectively F1˜F3. For example, F2=F1−5 MHz, and F3=F1+5 MHz.

The signal strengths measured by filters 1˜3 are illustrated in FIG. 11B, wherein symbols 1101˜1103 denotes the signal strengths measured by filters 1˜3 respectively. Suppose signal strength 1103 is smaller than signal strength 1102.

There is one condition to be satisfied: the signal strength measured in the middle frequency cannot be smaller than the signal strength measured in high frequency and that measured in low frequency at the same time. That is, signal strength 1101 cannot be smaller than both signal strengths 1102 and 1103. If this condition is not satisfied, then the MPE method of the sixth embodiment of the invention will not be started.

Next, a line L1 is drawn which passes the signal strength 1101 and the signal strength 1103 (to be more correctly, the smaller of the signal strengths 1102 and 1103). Assume the slope of the line L1 is X.

Next, another line L2 with slope −X is drawn which passes through signal strength 1101 and signal strength 1102 (to be more correctly, the larger of signal strengths 1102 and 1103). The frequency at the crossing point of the lines L1 and L2 is close to the center frequency Fc.

FIG. 12 shows a flowchart of a GBD method for scanning correct channel according to the sixth embodiment of the invention.

In step 1205, the signal strengths in different frequencies are measured. For example, as indicated in FIG. 11A, at least the signal strengths in three different frequencies are measured. However, the invention is not limited thereto, and the signal strengths in more frequencies can be measured. After that, the method proceeds to step 1210 and it is checked that whether the above conditions are satisfied.

If the check result in step 1210 is no, then the method jumps to step 1215. If the check result in step 1210 is yes, then the method jumps to step 1220.

In step 1215, a channel is selected randomly or sequentially (from high frequency to low frequency or from low frequency to high frequency).

In step 1220, center frequency is predicted according to the above MPE method. Then, the method proceeds to step 1225 and a channel is selected from channels nearby to channels afar according to the predicted center frequency. “A channel is selected from channels nearby to channels afar” means the predicted center frequency is used as a reference point, and in the direction moving away from the reference point, the next channel (center frequency) is selected alternately (high frequency followed by low frequency or low frequency followed by high frequency).

In step 1230, the operations of timing synchronization, estimation, decoding, authorization and so on are performed in the selected channel. In step 1235, it is checked that whether authorization is passed. If authorization is passed, this implies that the selected channel is exactly the correct channel. If authorization is not passed, then the method returns to step 1215 (if channel is selected according to step 1215) or jumps to step 1225 (if channel is selected according to steps 1220˜1225).

Also, in the sixth embodiment, the parameter (the slope of the line L1 or L2) used for estimation may be non-linear; and the line L1 or L2 is not limited to be a straight line.

### Seventh Embodiment

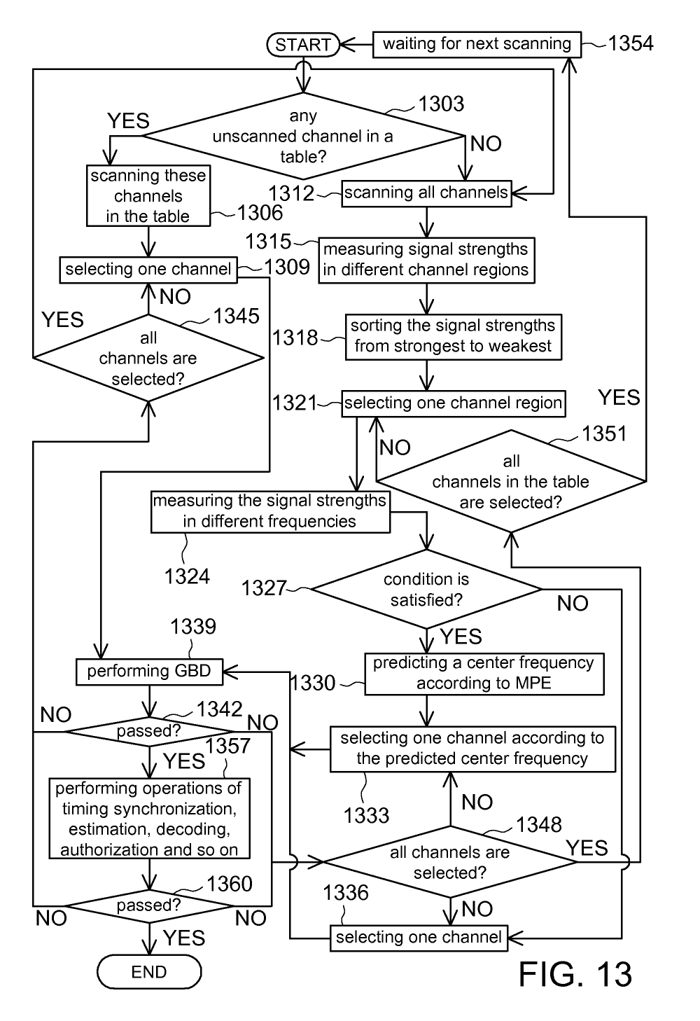

The seventh embodiment of the invention uses both GBD and MPE to speed up scanning channels and frequencies. FIG. 13 shows a flowchart of a GBD method for scanning correct channel according to the seventh embodiment of the invention. Steps 1303˜1360 of FIG. 13 are similar or identical to the steps of the above embodiments and the details are not repeated.

Despite FIG. 13 is exemplified by the GBD of the second embodiment and the MPE method of sixth embodiment, the use of the GBD and the MPE method of other embodiments are still within the spirit of the invention.

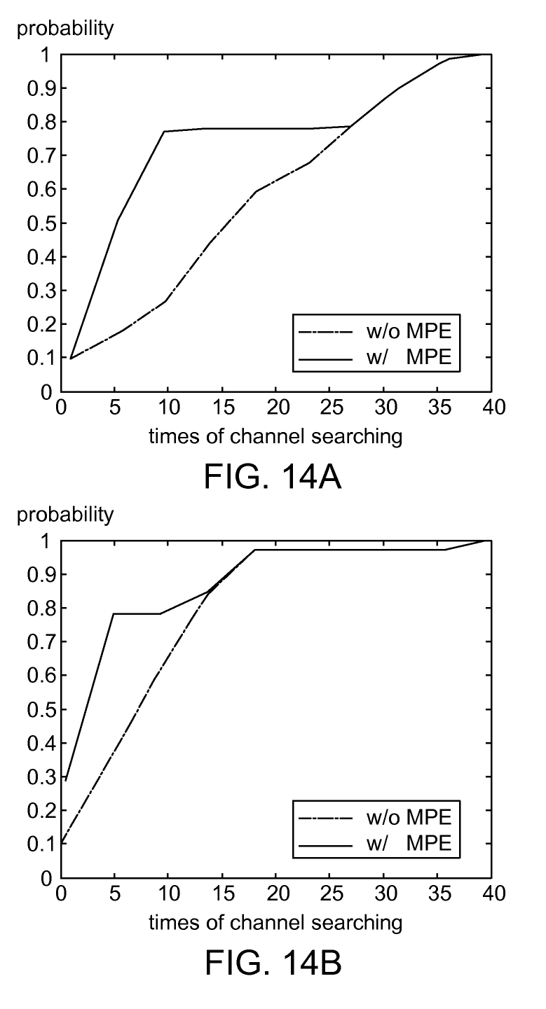

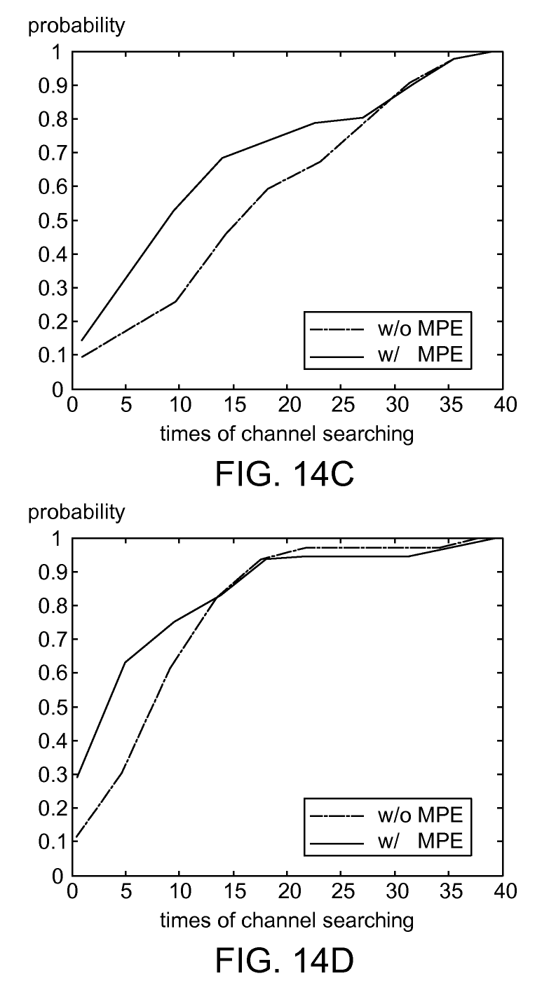

xul3ru, FIG. 14A˜FIG. 14D show simulation curves obtained according the seventh embodiment (solid line) and the second embodiment (dotted line) of the invention. In FIG. 14A˜FIG. 14D, the horizontal axis denotes channel search times (the required searching times for scanning the correct channel), and the vertical axis denotes accumulative probability. The less the channel searching times is, the faster the correct channel will be scanned and lesser the power is consumed.

The simulation scenarios of FIG. 14A are: the middle location, AWGN, cell plan 3×3×3 and 7 cells. The simulation scenarios of FIG. 14B are: the middle location AWGN, cell plan 1×3×3 and 7 cells. The simulation scenarios of FIG. 14C are: the middle location, VA 60 Km/hr, cell plan 3×3×3 and 7 cells. The simulation scenarios of FIG. 14D are: the middle location, VA 60 Km/hr, cell plan 1×3×3 and 7 cells.

As indicated in simulation, the probability that the channel searching times is smaller than 10 is increased by 30%˜50%.

In the seventh embodiment of the invention, before selecting the channel, the MPE method can be used to predict approximate location of the center frequency and the correct channel. After that, subsequent operations of authorization and so on are performed in the predicted center frequency (channel). Thus, the times of and time taken on performing subsequent processes in some channel farther away from the correct channel are largely reduced.

### Eighth Embodiment

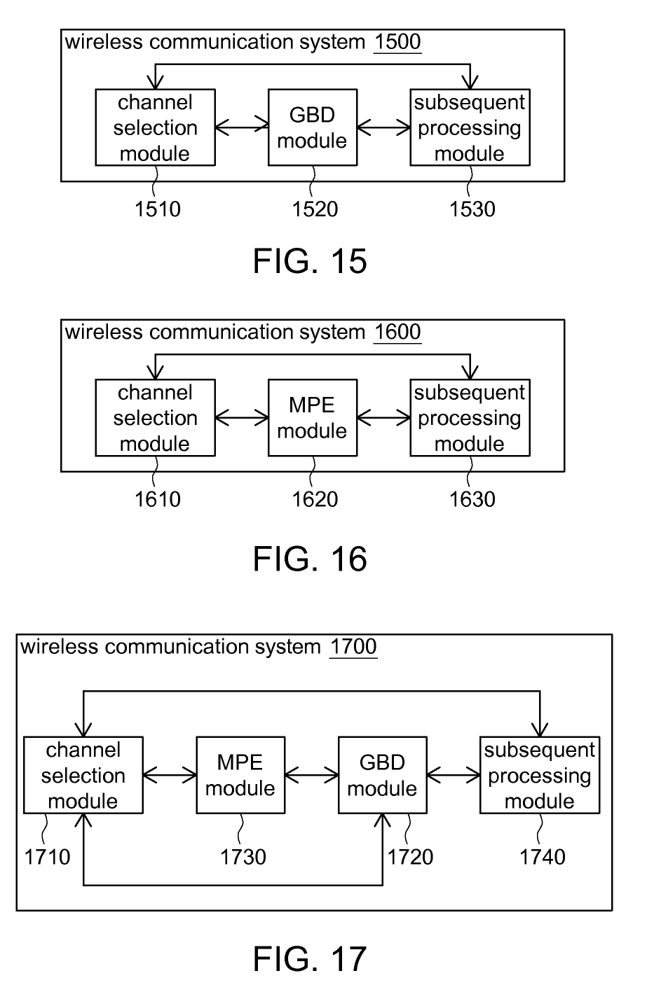

The eighth embodiment of the invention discloses a wireless communication system. FIG. 15 shows a function block diagram of wireless communication system 1500 according to the eighth embodiment of the invention. As indicated in FIG. 15, the wireless communication system 1500 at least comprises a channel selection module 1510, a GBD module 1520 and a subsequent processing module 1530.

The channel selection module 1510 can select one channel from several channels. The details of the channel selection module 1510 can be referred from the above embodiments of the invention and are not repeated here.

The GBD module 1520 performs GBD in the selected channels. The details of the GBD module 1520 can be referred from the above embodiments of the invention and are not repeated here.

The subsequent processing module 1530 performs subsequent processes such as timing synchronization, estimation, decoding, authorization and so on in the channel.

### Ninth Embodiment

The ninth embodiment of the invention discloses a wireless communication system. FIG. 16 shows a function block diagram of wireless communication system 1600 according to the ninth embodiment of the invention. As indicated in FIG. 16, the wireless communication system 1600 at least comprises a channel selection module 1610, an MPE module 1620 and a subsequent processing module 1630.

The channel selection module 1610 can select one channel from several channels. The details of the channel selection module 1610 can be referred from the above embodiments of the invention and are not repeated here.

MPE module 1620 performs MPE in the selected channels. The details of the MPE module 1620 can be referred from the above embodiments of the invention and are not repeated here.

The subsequent processing module 1630 performs subsequent process such as timing synchronization, estimation, decoding, authorization and so on in the channel.

### Tenth Embodiment

The tenth embodiment of the invention discloses a wireless communication system. FIG. 17 shows a function block diagram of wireless communication system 1700 according to the tenth embodiment of the invention. As indicated in FIG. 17, the wireless communication system 1700 at least comprises a channel selection module 1710, a GBD module 1720, an MPE module 1730 and a subsequent processing module 1740.

The channel selection module 1710 can select one channel from several channels. The details of the channel selection module 1710 can be referred from the above embodiments of the invention and are not repeated here

The GBD module 1720 performs GBD in the selected channels. The details of the GBD module 1720 can be referred from the above embodiments of the invention and are not repeated here.

The MPE module 1730 performs MPE in the channel. The details of the MPE module 1730 can be referred from the above embodiments of the invention and are not repeated here.

The subsequent processing module 1740 performs subsequent process (such as timing synchronization, estimation, decoding, authorization and so on in the channel.

While the invention has been described by way of examples and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless communication method, comprising:
selecting one channel from a plurality of channels;
performing a guard band detection (GBD) in the selected channel to detect existence of a guard band of a correct channel;
performing a subsequent process in the selected channel if the GBD is passed in the selected channel; and
determining the selected channel as the correct channel if the subsequent process is passed in the selected channel.

2. The wireless communication method according to claim 1, wherein the step of selecting one channel from the plurality of channels further comprises:
checking whether there is any unscanned channel in a table;
scanning these channels in the table and selecting one from the channels in the table, if the result in the step of checking whether there is any unscanned channel in the table is yes; and
scanning all channels, measuring signal strengths in all channel regions, sorting the measured signal strengths, selecting one of the channel regions according to the result of sorting, and selecting one channel from the selected channel region, if the result in the step of checking whether there is any unscanned channel in the table is no.

3. The wireless communication method according to claim 1, wherein the step of selecting one channel from the plurality of channels further comprises:
measuring signal strengths in the channels;
sorting the measured signal strengths; and
selecting one from the channels according to the result of sorting.

4. The wireless communication method according to claim 1, wherein the step of selecting one channel from the plurality of channels further comprises:
checking whether there is any unscanned channel in a table;
scanning the channels in the table and selecting one from the channels in the table if the result in the step of checking whether there is any unscanned channel in the table is yes; and
scanning all channels and selecting one from the channels if the result in the step checking whether there is any unscanned channel in the table is no.

5. The wireless communication method according to claim 1, wherein the step of selecting one channel from the plurality of channels further comprises:
checking whether there is any unscanned channel in a table;
scanning the channels in the table and selecting one from the channels in the table if the result in the step of checking whether there is any unscanned channel in the table is yes; and
scanning these channels, measuring signal strengths in the channels, sorting the measured signal strengths and selecting one channel from the channels according to the result of sorting if the result in the step of checking whether there is any unscanned channel in the table is no.

6. The wireless communication method according to claim 1, wherein the step of performing the GBD in the selected channel to detect existence of the guard band of the correct channel further comprises:
dividing a plurality of sub-carriers in a bandwidth of the selected channel into a plurality of sub-groups;
obtaining respective sub-carrier average power values of the sub-groups; and
determining whether the GBD is passed in the selected channel according to distribution of the sub-carriers average power values

7. A wireless communication method, comprising:
measuring signal strengths in different frequencies respectively;
checking whether the characteristics of the signal strengths are conformed to a condition;
predicting a frequency according to the characteristics of the signal strengths and selecting one channel according to the predicted frequency if the condition is conformed; and
determining the selected channel as a correct channel if a subsequent process is passed in the selected channel.

8. The wireless communication method according to claim 7, wherein:
the step of measuring signal strengths in different frequencies respectively further comprises:
measuring a first, a second and a third signal strength in a first, a second and a third frequency respectively, wherein the second frequency ranges between the first and the third frequency;
the step of checking whether the characteristics of the signal strengths are conformed to the condition further comprises:
checking whether the second signal strength is smaller than the first and the third signal strength; and
the step of predicting the frequency according to the characteristics of the signal strengths and selecting one channel according to the predicted frequency if the condition is conformed further comprises:
obtaining a first characteristics curve according to the first and the second signal strength;
obtaining a second characteristics curve according to the first characteristics curve, the second and the third signal strength; and
predicting a fourth frequency according to the relationship between the first characteristics curve and the second characteristics curve, and selecting the channel according to the fourth frequency which is predicted.

9. A wireless communication method, comprising:
measuring signal strengths in different frequencies respectively;
checking whether the characteristics of these signal strengths are conformed to a condition;
predicting a frequency according to the characteristics of the signal strengths and selecting one channel according to the predicted frequency if the condition is conformed;
performing a guard band detection (GBD) in the selected channel to detect the existence of a guard band of a correct channel; and
checking whether the GBD and a subsequent process are both passed in the selected channel to determine whether the selected channel is the correct channel.

10. The wireless communication method according to claim 9, wherein:
the step of measuring signal strengths in different frequencies respectively further comprises:
measuring a first, a second and a third signal strength in a first, a second and a third frequency respectively, wherein the second frequency ranges between the first and the third frequency;
the step of checking whether the characteristics of these signal strengths are conformed to the condition further comprises:
checking whether the second signal strength is smaller than the first and the third signal strength;
the step of predicting the frequency according to the characteristics of the signal strengths and selecting one channel according to the predicted frequency if the condition is conformed further comprises:
obtaining a first characteristics curve according to the first and the second signal strength;
obtaining a second characteristics curve according to the first characteristics curve, the second and the third signal strength; and
predicting a fourth frequency according to the relationship between the first characteristics curve and the second characteristics curve and selecting the channel according to the fourth frequency which is predicted.

11. The wireless communication method according to claim 9, wherein the step of performing the GBD in the selected channel to detect the existence of the guard band of the correct channel further comprises:
dividing a plurality of sub-carriers in a bandwidth of the selected channel into a plurality of subgroups;
obtaining respective sub-carrier average power values of the sub-groups; and
checking whether the GBD is passed in the selected channel according to the distribution of the average power values in the sub-carriers.

12. The wireless communication method according to claim 9, wherein
before the step of measuring signal strengths in different frequencies respectively, the method further comprises:
scanning all channels;
measuring signal strengths in all channel regions;
sorting the measured signal strengths;
selecting one channel region according to the result of sorting; and
selecting the different frequencies according to the selected channel region; or,
before the step of measuring signal strengths in different frequencies respectively, the method further comprises:
measuring signal strengths in all channels;
sorting the measured signal strengths; and
selecting these different frequencies according to the result of sorting; or
before the step of measuring signal strengths in different frequencies respectively, the method further comprises:
checking whether there is any unscanned channel in a table;
scanning the channels in the table, selecting the different frequencies according to the channels in the table if the result in the step of checking whether there is any unscanned channel in the table is yes; and
scanning all channels and selecting these different frequencies according to the scanned channels if the result in the step of checking whether there is any unscanned channel in the table is no.

13. A wireless communication system, comprising:
a channel selection module for selecting one channel from a plurality of channels;
a GBD module coupled to the channel selection module, for performing a GBD in the selected channel to detect the existence of a guard band of a correct channel; and
a subsequent processing module coupled to the GBD module, for performing a subsequent process in the channel having been passed, wherein the selected channel is determined as the correct channel if the subsequent process is passed in the channel.

14. The wireless communication system according to claim 13, wherein the channel selection module checks whether there is any unscanned channel in a table; scans the channels in the table and selects one channel from the channels in the table if the checking result is yes; and scans all channels, measures signal strengths in all channel regions, sorts the measured signal strengths, selects a channel region according to the result of sorting, and selects one channel from the selected channel region if the checking result is no.

15. The wireless communication system according to claim 13, wherein the channel selection module measures signal strengths in the channels; sorts the measured signal strengths; and selects one channel according to the result of sorting.

16. The wireless communication system according to claim 13, wherein the channel selection module checks whether there is any unscanned channel in a table; scans the channels in the table and selects one channel from the channels in the table if the checking result is yes; and scans all channels, and selects one channel from the channels if the checking result is no.

17. The wireless communication system according to claim 13, wherein the channel selection module checks whether there is any unscanned channel in a table; scans the channels in the table and selects one channel from the channels in the table if the checking result is yes; and scans the channels, measures signal strengths in the channels, sorts the measured signal strengths and selects one channel according to the result of sorting if the checking result is no.

18. The wireless communication system according to claim 13, wherein the GBD module divides a plurality of sub-carriers in a bandwidth of the selected channel into a plurality of sub-groups; obtains respective sub-carrier average power values of the sub-groups; and checks whether the GBD is passed in the selected channel according to the distribution of the average power values in the sub-carriers.

19. A wireless communication system, comprising:
an MPE module, for measuring signal strengths in different frequencies respectively, checking whether the characteristics of the signal strengths are conformed to a condition, and predicting a frequency according to the characteristics of the signal strengths and selecting one channel according to the predicted frequency if the condition is conformed; and
a subsequent processing module coupled to the MPE module, wherein if the subsequent processing module determines that a subsequent process is passed in the selected channel, then the selected channel is determined as a correct channel.

20. The wireless communication system according to claim 19, wherein the MPE module measures a first, a second and a third signal strength in a first, a second and a third frequency respectively, wherein the second frequency ranges between the first and the third frequency; checks whether the second signal strength is smaller than the first and the third signal strength; obtains a first characteristics curve according to the first and the second signal strength, if the condition is conformed; obtains a second characteristics curve according to the first characteristics curve, the second and the third signal strength; and predicts a fourth frequency according to the relationship between the first characteristics curve and the second characteristics curve and selects one channel according to the fourth frequency which is predicted.

21. A wireless communication system, comprising:
an MPE module, for measuring signal strengths in different frequencies respectively, checking whether the characteristics of the signal strengths are conformed to a condition, and predicting a frequency according to the characteristics of the signal strengths in the different frequencies and selecting one channel according to the predicted frequency if the condition is conformed;
a GBD module coupled to the MPE module, for performing a GBD in the selected channel to detect existence of a guard band of a correct channel; and
a subsequent processing module coupled to the MPE module and the GBD module, wherein the subsequent processing module performs a subsequent process in the channel having been passed the GBD to determine whether the channel is the correct channel.

22. The wireless communication system according to claim 21, wherein the MPE module measures a first, a second and a third signal strength in a first, a second and a third frequency respectively, wherein the second frequency ranges between the first and the third frequency; checks whether the second signal strength is smaller than the first and the third signal strength; obtains a first characteristics curve according to the first and the second signal strength if the condition is conformed; obtains a second characteristics curve according to the first characteristics curve, the second and the third signal strength; and predicts a fourth frequency according to the relationship between the first characteristics curve and the second characteristics curve and selecting one channel according to the fourth frequency.

23. The wireless communication system according to claim 21, wherein the GBD module divides a plurality of sub-carriers in a bandwidth of the selected channel into a plurality of sub-groups; obtains respective sub-carrier average power values of these sub-groups; and checks whether the GBD is passed in the selected channel according to the distribution of the average power values in the sub-carriers.

24. The wireless communication system according to claim 21, further comprising
a channel selection module coupled to the MPE module and the GBD module, wherein
the channel selection module scans all channels; measures signal strengths in all channel regions; sorts the measured signal strengths; selects a channel region according to the result of sorting; and selects the different frequencies according to the selected channel region; or
the channel selection module measures signal strengths in all channels; sorts the measured signal strengths; and selects the different frequencies according to the result of sorting; or,
the channel selection module checks whether there is any unscanned channel in a table; scans the channels in the table and selects the different frequencies according to the channels in the table if the checking result is yes; scans all channels; and selects the different frequencies according to the scanned channels if the checking result is no.
